(19) United States
(12) Patent Application Publication
(10) Pub. No.: US 2002/0033242 A1
(43) Pub. Date: Mar. 21, 2002

(54) Safety for garage doors using mechanical designs by utilizing the automatic braking mechanism design

(76) Inventors: Henri J. K. Kassab, Stamford, CT (US); Roger J. Kassab, Shrewsbury, MA (US)

Correspondence Address: HENRI J. K. KASSAB, APT # 4N, 27 NORTHILL STREET, STAMFORD, CT, 06907, US

(21) Appl. No.: 09/944,806

(22) Filed: Aug. 31, 2001

Related U.S. Application Data
(62) Division of application No. 09/654,770, filed on Sep. 5, 2000.

(51) Int. Cl. E05D 15/16

(52) U.S. Cl. 160/201

(57) ABSTRACT

This patent application addresses people's safety when utilizing garage doors. It is aimed at fortifying the safety of garage door utilization. This is accomplished by adding a braking mechanism design onto the garage doors that stops the doors from shutting down when an object or a person or an animal is in its path. It is a mechanical invention and could apply to existing garage doors or introduced into a new door designs.

### FIELD OF THE INVENTION

This invention relates to the safety features offered around garage doors utilized in houses and businesses.

This document references the following application for patent which is in review at this time: Application # 09/654,770 filing date Sept. 5, 2000, Applicant (s) Kassab et al, Art unit 3634

### DISCUSSION

Present garage doors whether used in houses or in shops or automobile garages etc. . . . represent a certain threat to the safety of the individuals who come to operate them and utilize their functions. The application of extra precautionary mechanical invention designs would apply whether or not the doors have a remotely controlled motor attached. And should also apply for doors which operate in the vertical direction and also for ones that operate in the horizontal one. The present Garage Doors design is not full proof and the safety of the person(s) who pass(es) in the pathway of these doors become(s) questionable when the sensors adjustment is out of alignment, or the actual sensing devices become defective. By using mechanically designed features one could reduce if not totally prevent serious injury to persons or domestic animals from happening. Therefore, incidents that happen, especially on doors which are motor remote operated, due to the sensor not being adjusted properly by the installer or the sensor may have gone out of alignment which renders the retraction of the door inoperable and hence becomes a big safety as well as a liability issue. Furthermore, it could become a life threatening situation for young or little children or small animals. Moreover, for doors that are manually operated there is a greater danger since there is no protection at all on the doors. In all situations, whether the doors are shut erroneously while a person is pulling on a chain or pulling on the door itself to close it, or whether the retract mechanism does not exist on the door itself (Some older models do not have any safety features) or whether just the pound pressure for re-tract of the door is not properly set, or whether the electrical motor sensing device is defective or out of alignment, the end result could be injury to adults in best case and potentially fatal to young children (also animals). In short the people's safety is compromised without the proposals mentioned in this document that introduces the extra mechanical design to enhance the safety of operation of the garage doors. This document discloses the idea of using a mechanical design invention as well as multiple separate inventions to accomplish safer Garage Door operation.

### SUMMARY OF THE INVENTION

The present/older inventions for operating Garage doors do not provide a complete safe solution to warrant the safety of the individuals using them and in some cases may become life threatening when miss used. The invention that is discussed in here provides an independent layer of safety on top of what is presently designed which is the retraction of the motor (if present) upon impact. The proposed solution is a mechanism that is purely mechanical in such a manner to prevent the door from crushing the object or the person standing or passing through its travel path. The mechanical invention consists of a mechanical braking mechanism that will halt the door upon collision with a person or an object. The mechanical braking mechanism design works when the brakes are applied only in the direction of closing the door while allowing the door to be free to re-tract to open position (when a garage door is equipped with a motor). If there is not a motor operated device used then the door will remain in braking position until the obstruction is removed.

### A BRIEF DESCRIPTION OF THE DRAWINGS

Note: the word Figure will be abbreviated as FIG in the rest of this document.

THE UTILIZATION OF THE AUTOMATIC BRAKING MECHANISM

This design relies on applying breaks to halt the door movement when it is moving.

FIG. 5 shows the whole design. A rubber soft material attaches to a metal bar, which goes below the bottom of the B piece. And is free to move in the upward direction when a person or an object collides with it. Upon an impact the bar moves in the upward direction, which will cause the motion of the breaks to go towards the center of the B piece from either side of the door. The pads are designed such that they have unidirectional teeth that will meet the teeth on the garage door rail and both of these will halt the door from moving until what got in the way of the door is removed. The teeth unidirectional design allows them to halt the door when moving to the closing position but yet also allows the door to retract freely if equipped with an electrical re-tract safety feature. Of-course when the door re-tracts the obstacle will not be touching the Metal Bar with rubber soft material on its end and the brakes will disengage also. A spring (not shown on the graph) will be used to position the break pads in idle position (away from the Track/Rail of garage door) if the weight of the bar does not re-tract the pads 100% of the time. In the fully closed garage door position it is OK for the brakes to be applied.

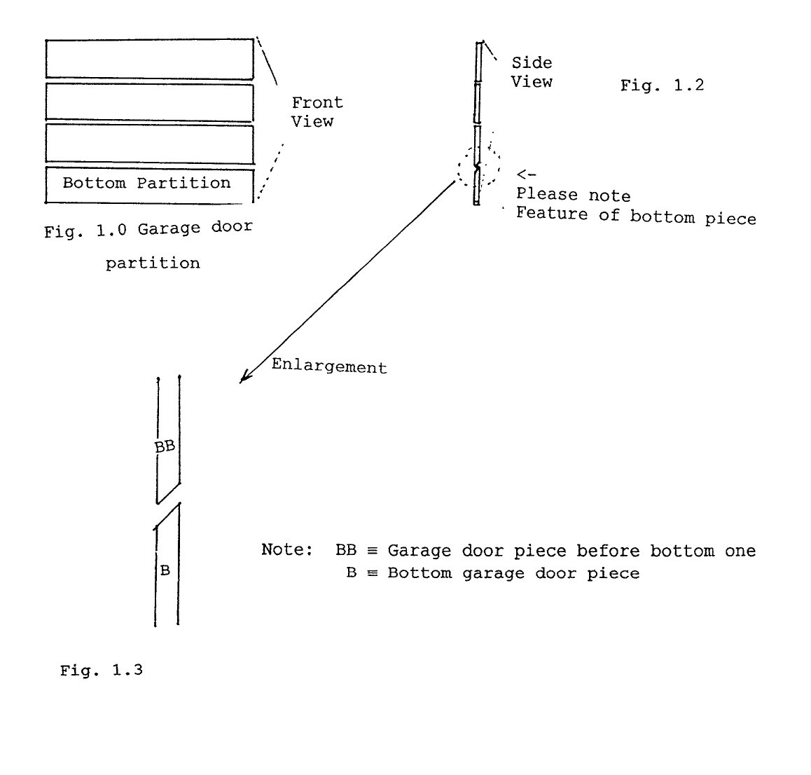

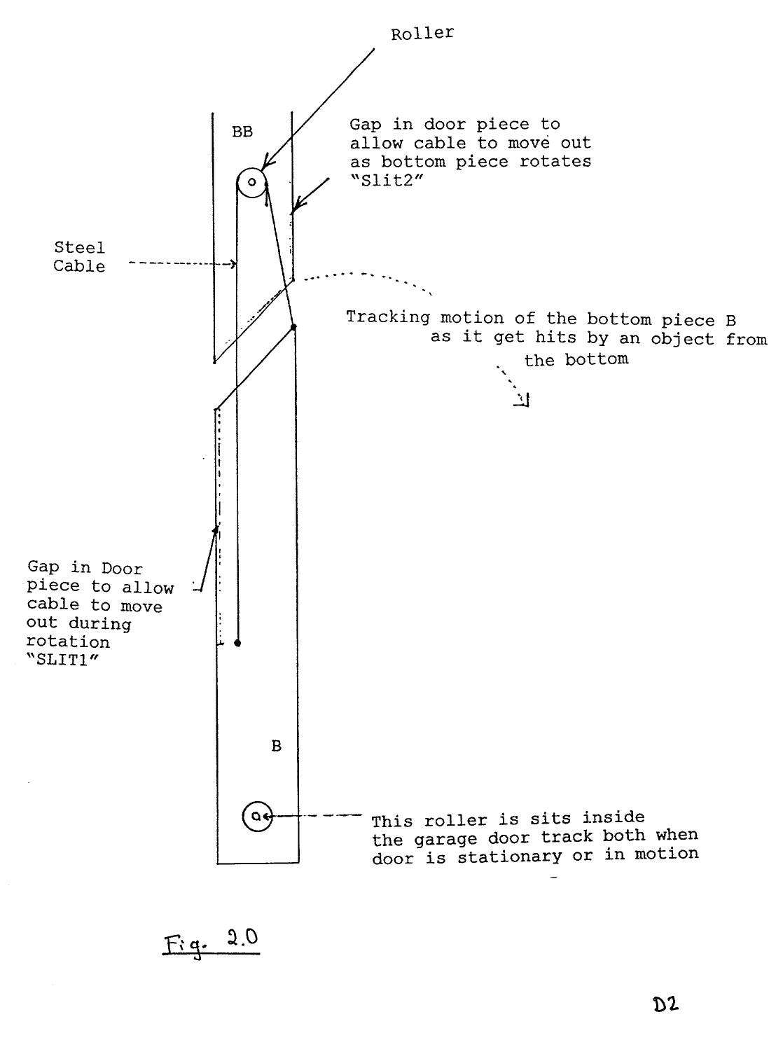

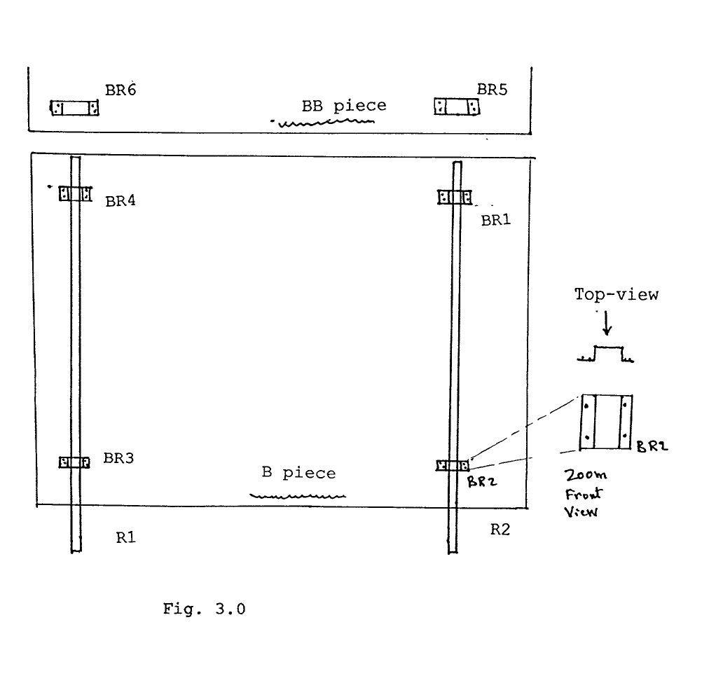

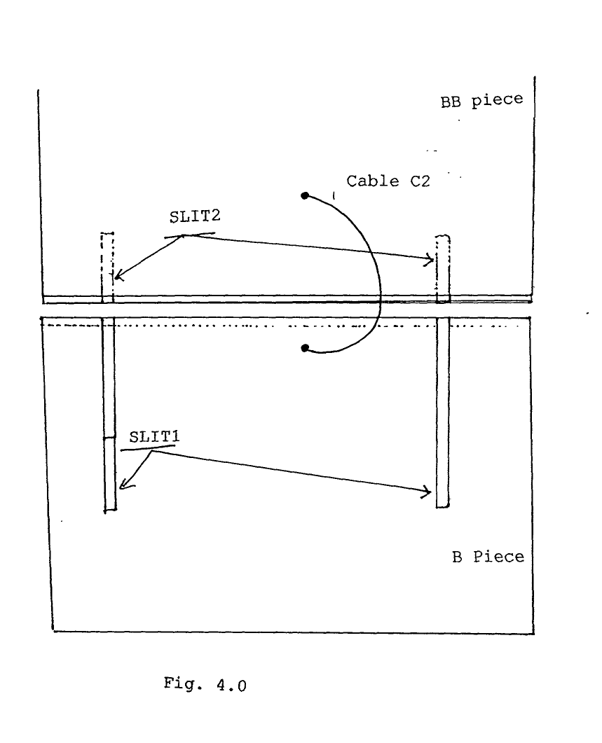

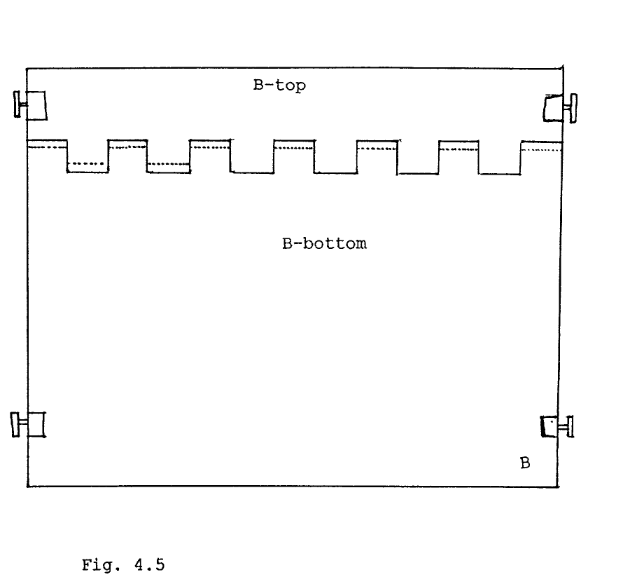

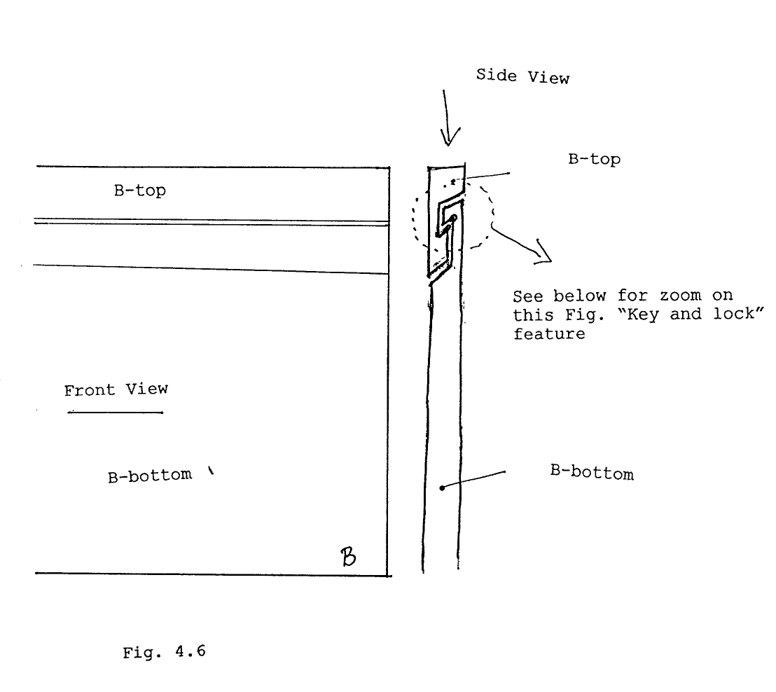

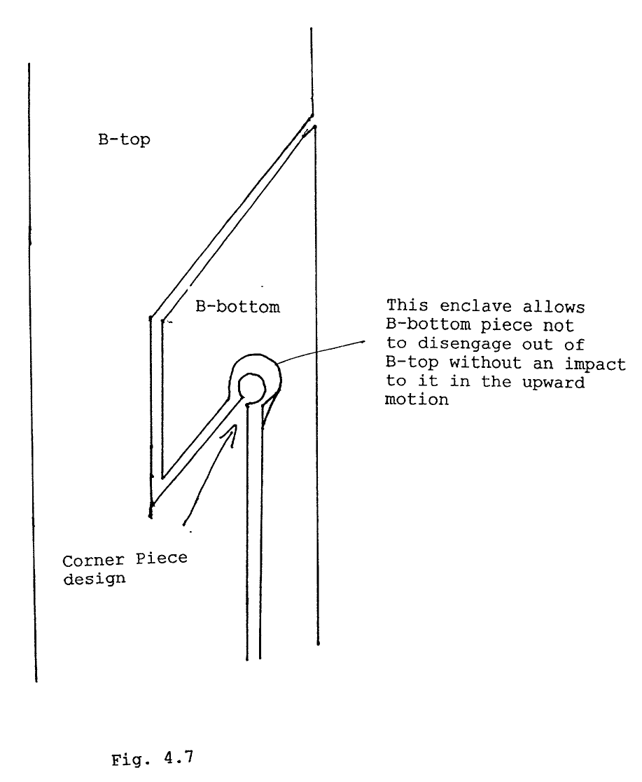

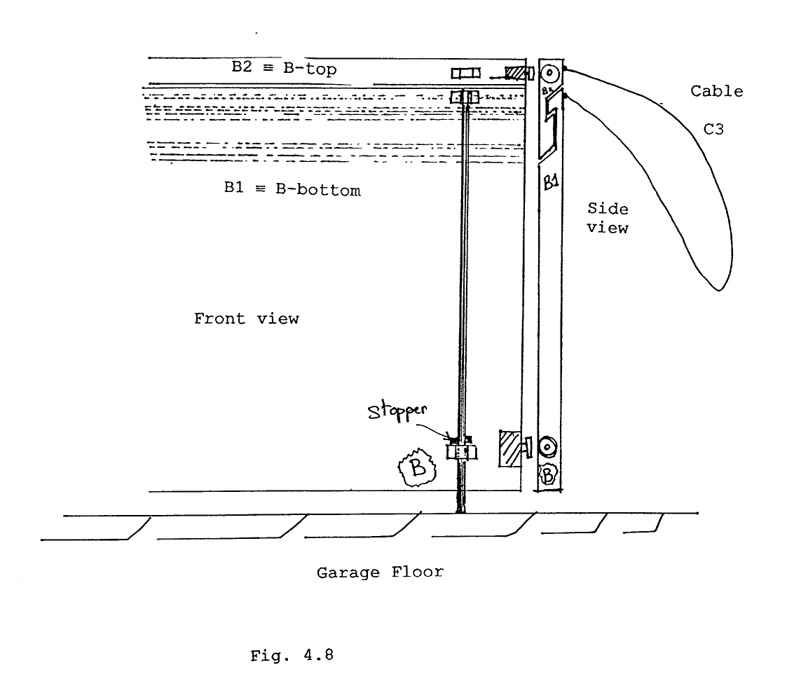

This design can be imbedded inside the door for new manufactured door or retrofitted on existing installed doors. The intention in here is not to finalize this design but rather to claim the braking system and all the features that have been introduced in this document. Hence, to claim this particular implementation. This design references

### DETAILED DESCRIPTION OF THE INVENTION

The mechanical automatic braking mechanism stops the door upon impact. This invention could go easily on older doors and newly designed doors or it could be included into new door designs. The design includes a bar that spans the entire end piece side to side (or top to bottom for left to right (L2R) moving doors) of the garage door and sits a few inches from the end of the end piece of the garage door. Upon impact of the bar against an object or a person it will move towards the bottom (or side for L2R depending on Garage door orientation and travel) end piece of the garage door. During this movement a mechanical mechanism will move to apply the brake to the side of the rail that the door is hung from. Once the brake is applied it will prevent the actual end piece of the garage door from continuing to travel to the closing position, which will disallow the object or person from being crushed by it. Furthermore, for motor operated garage doors the brake will not prevent the door from retracting because of interface between the brake pad and the design of the teeth that are attached to the rails. They are designed such that they will interlock in the closing travel but are free to get loose in the opening travel of the garage door. When the metal bar is pressed it will activate the braking pedal which will move the brake pad towards the teeth that are attached to the rail and it would hook on to it as long as there is an obstacle that is pressing against the bar or until the door retracts to the open position when equipped with a motor that is designed to sense this condition. For the case of the doors that are not operated by motors or with motors with without re-tract safety feature the brake will stay applied until the obstacle is removed.

We, Henri J. K. Kassab and Roger J. Kassab claim the following:

1. The idea of the “Mechanical Automatic Breaking mechanism” to stop the door from pressing against an obstacle and crushing it. As well as the designs and features depicted and implied in this document.
